(19) United States
(12) Patent Application Publication
(10) Pub. No.: US 2020/0240186 A1
(43) Pub. Date: Jul. 30, 2020

(54) SLIDING DOOR STRUCTURE AND VEHICLE

(71) Applicant: HONDA MOTOR CO., LTD., TOKYO (JP)

(72) Inventors: Masaya KUROIWA, WAKO-SHI (JP); Ken YASUI, WAKO-SHI (JP); Takashi KATO, WAKO-SHI (JP)

(21) Appl. No.: 16/774,327

(22) Filed: Jan. 28, 2020

(30) Foreign Application Priority Data
Jan. 29, 2019 (JP) 2019-012732

(51) Int. Cl. E05D 15/06; B60J 5/06; E05D 15/30; B60J 5/04

(52) U.S. Cl. CPC E05D 15/0665; B60J 5/062; E05Y 2900/531; E05D 15/30; B60J 5/047; E05D 15/0691

(57) ABSTRACT

A sliding door structure includes a rotary part that can rotate with respect to a door, a pair of first rollers holding a first guide rail therebetween, a pair of second rollers holding a second guide rail therebetween, a first roller support part that rotatably supports the pair of first rollers and can rotate with respect to the rotary part, and a second roller support part that rotatably supports the pair of second rollers and can rotate with respect to the rotary part.

### CROSS-REFERENCE TO RELATED APPLICATION

This application is based upon and claims the benefit of priority from Japanese Patent Application No. 2019-012732 filed on Jan. 29, 2019, the contents of which are incorporated herein by reference.

### BACKGROUND OF THE INVENTION

### Field of the Invention

The present invention relates to a sliding door structure and a vehicle.

### Description of the Related Art

Japanese Patent No. 5238266 has suggested a vehicle with a sliding door structure.

### SUMMARY OF THE INVENTION

In the conventional technique, the space for providing the sliding door structure has not necessarily been small sufficiently.

It is an object of the present invention to provide a sliding door structure and a vehicle that can achieve space saving.

A sliding door structure according to one aspect of the present invention includes: a door configured to cover an opening formed at a side part of a vehicle body; a lower rail disposed below the opening, including a first guide rail and a second guide rail formed along the first guide rail, and configured to support the door slidably in a front-rear direction of the vehicle body; a rotary part disposed at a lower part of the door and configured to rotate with respect to the door; a pair of first rollers holding the first guide rail therebetween; a pair of second rollers holding the second guide rail therebetween; a first roller support part provided to the rotary part and configured to rotatably support the pair of first rollers and rotate with respect to the rotary part; and a second roller support part provided to the rotary part and configured to rotatably support the pair of second rollers and rotate with respect to the rotary part.

A vehicle according to another aspect of the present invention includes the sliding door structure as described above.

According to the present invention, the sliding door structure and the vehicle that can achieve space saving can be provided.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view illustrating a sliding door structure according to one embodiment;

FIG. 2 is a perspective view illustrating the sliding door structure according to the embodiment;

FIGS. 3A, 3B, 3C, and 3D illustrate a lower rail;

FIG. 4 is a perspective view illustrating a lower guide part;

FIG. 5 is a perspective view illustrating the lower guide part;

FIG. 6 is a side view illustrating the lower guide part;

FIG. 7 is a plan view illustrating an operation of the sliding door structure according to the embodiment;

FIG. 8 is a plan view illustrating the operation of the sliding door structure according to the embodiment;

FIG. 9 is a perspective view illustrating the lower guide part;

FIG. 10 is a plan view illustrating the operation of the sliding door structure according to the embodiment;

FIG. 11 is a plan view illustrating the operation of the sliding door structure according to the embodiment;

FIG. 12 is a plan view illustrating the operation of the sliding door structure according to the embodiment;

FIG. 13 is a cross-sectional view illustrating a part of a vehicle according to the embodiment;

FIG. 14 is a cross-sectional view illustrating a part of a vehicle according to a comparative example;

FIG. 15A is a perspective view illustrating a battery case provided in the vehicle according to the embodiment, and FIG. 15B is a perspective view illustrating a battery case provided in the vehicle according to the comparative example; and

FIG. 16A is a perspective view illustrating a part of the vehicle according to the embodiment, and FIG. 16B is a perspective view illustrating a part of the vehicle according to the comparative example.

### DESCRIPTION OF THE PREFERRED EMBODIMENT

A preferred embodiment of a sliding door structure and a vehicle according to the present invention is hereinafter described in detail with reference to the attached drawings.

[Embodiment]

The sliding door structure and the vehicle according to the embodiment are described with reference to the drawings.

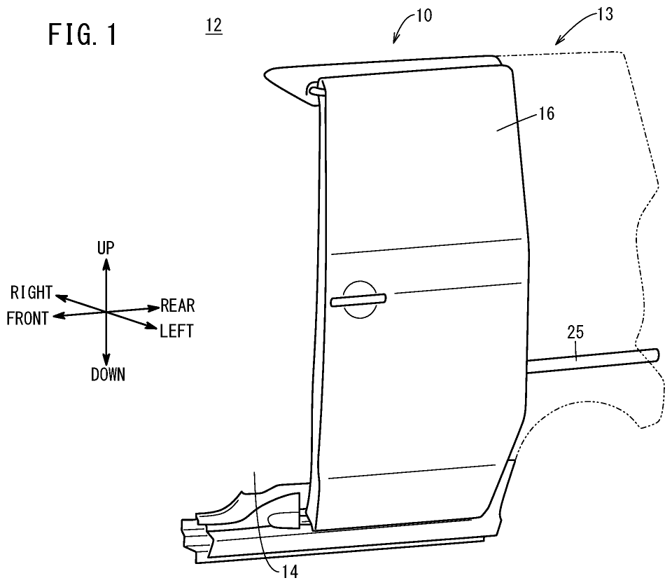

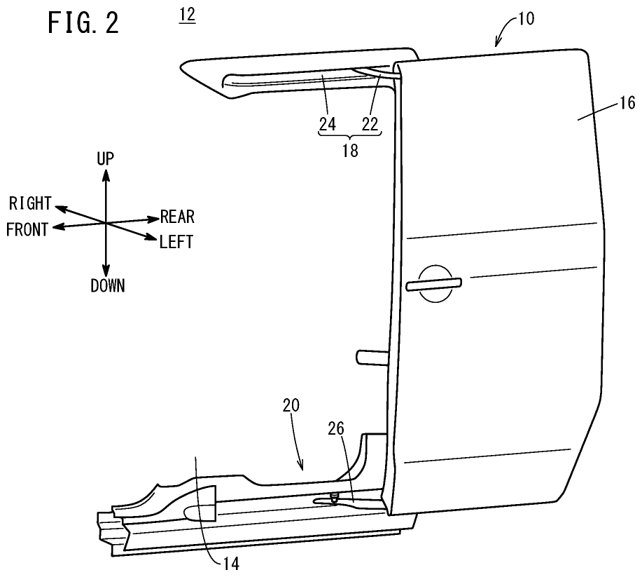

FIG. 1 and FIG. 2 are perspective views each illustrating the sliding door structure according to the present embodiment. FIG. 1 illustrates a state in which a sliding door 16 is closed. FIG. 2 illustrates a state in which the sliding door 16 is open.

As illustrated in FIG. 1, a vehicle 12 includes a vehicle body 13. At a side part of the vehicle body 13, an opening 14 is formed. The opening 14 is for a user (occupant, not illustrated) to get in and out of the vehicle 12. The opening 14 is formed to have a rectangular shape as a whole.

At the side part of the vehicle body 13, a sliding door structure 10 is provided. Although the sliding door structure 10 is provided on the left side of the vehicle body 13 here, the present invention is not limited to this example. The sliding door structure 10 includes the sliding door (door) 16 that can cover the opening 14. The sliding door 16 is formed to have a rectangular shape as a whole.

As illustrated in FIG. 2, the sliding door structure 10 further includes an upper support part 18 that supports an upper part of the sliding door 16, a center support part (not illustrated) that supports a center part of the sliding door 16, and a lower support part 20 that supports a lower part of the sliding door 16.

The upper support part 18 includes an upper guide part (guide part) 22 provided at the upper part of the sliding door 16, and an upper rail (upper sliding rail) 24 that can guide the upper guide part 22. The upper rail 24 is provided above the opening 14. The upper rail 24 slidably supports the sliding door 16 in a front-rear direction of the vehicle body 13.

The center support part includes a center guide part (not illustrated) provided at the center part of the sliding door 16, and a center rail (center sliding rail) 25 (see FIG. 1) that can guide the center guide part.

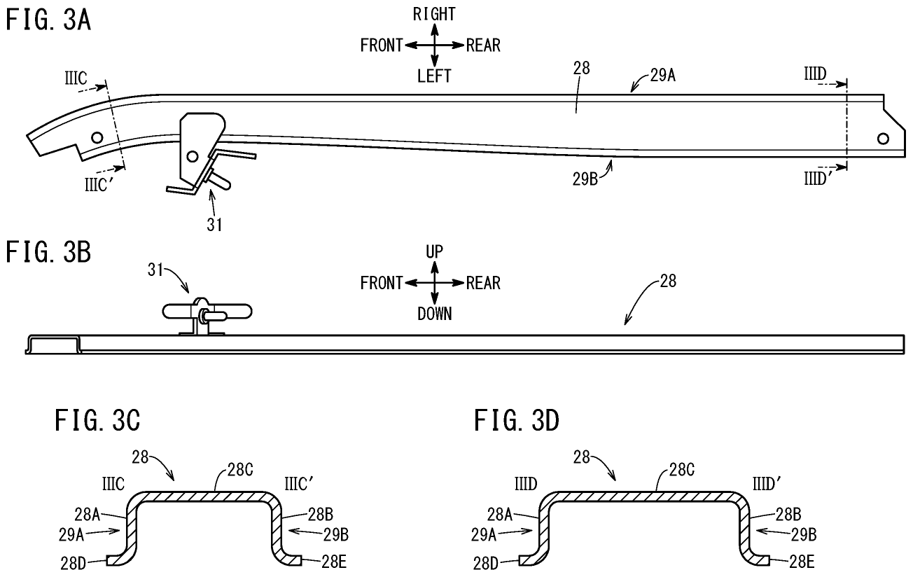

The lower support part 20 includes a lower guide part (guide part) 26 provided at the lower part of the sliding door 16, and a lower rail (lower sliding rail) 28 (see FIG. 3A to FIG. 3D) that can guide the lower guide part 26. The lower rail 28 is provided below the opening 14. The lower rail 28 slidably supports the sliding door 16 in the front-rear direction of the vehicle body 13.

FIG. 3A to FIG. 3D illustrate the lower rail. FIG. 3A is a plan view illustrating the lower rail. FIG. 3B is a side view illustrating the lower rail. FIG. 3C is a cross-sectional view taken along line IIIC-IIIC′ in FIG. 3A. FIG. 3D is a cross-sectional view taken along line IIID-IIID′ in FIG. 3A.

As illustrated in FIG. 3A, the lower rail 28 extends in the front-rear direction of the vehicle body 13. A front end part of the lower rail 28 is curved in a vehicle width direction. More specifically, the front end part of the lower rail 28 is separated more from a center line (not illustrated) of the vehicle body 13 in a longitudinal direction, in a direction from a rear end part to the front end part of the lower rail 28. In other words, the front end part of the lower rail 28 is curved more to the outside of the vehicle body 13 in the direction from the rear end part to the front end part of the lower rail 28.

As illustrated in FIG. 3C and FIG. 3D, the lower rail 28 includes a top part 28C, upright parts 28A and 28B positioned on both sides of the top part 28C, and flange parts 28D and 28E that protrude from the upright parts 28A and 28B to the outside of the lower rail 28, respectively.

The upright part 28B is formed along the upright part 28A. An upper part of the upright part 28A and an upper part of the upright part 28B are connected to each other by the top part 28C. The flange part 28D is connected to a lower part of the upright part 28A. The flange part 28E is connected to a lower part of the upright part 28B. The flange part 28D protrudes in a direction away from the upright part 28B. The flange part 28E protrudes in a direction of being separated from the upright part 28A. A normal direction of a main plane of the top part 28C, a normal direction of a main plane of the flange part 28D, and a normal direction of a main plane of the flange part 28E correspond to a vertical direction. A normal direction of the upright part 28A and a normal direction of the upright part 28B correspond to a horizontal direction. The lower rail 28 as described above is formed by, for example, press molding. On the top part 28C, a member 31 is attached. The member 31 is coupled to a front end part of the sliding door 16 when the sliding door 16 is closed.

The upright part 28A forms a first guide rail 29A. The upright part 28B forms a second guide rail 29B. The second guide rail 29B is formed along the first guide rail 29A. The distance between the first guide rail 29A and the second guide rail 29B in the vehicle width direction (left-right direction of vehicle body 13) is different depending on the position in a longitudinal direction of the lower rail 28 (front-rear direction of vehicle body 13).

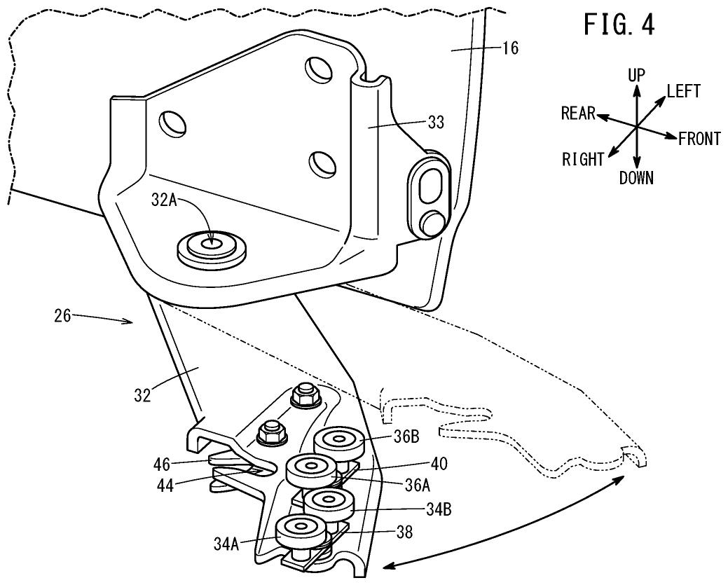

FIG. 4 is a perspective view illustrating the lower guide part.

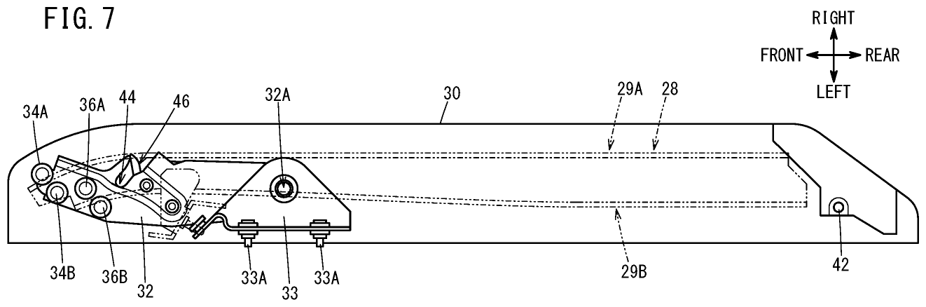

As illustrated in FIG. 4, a support member 33 is provided at the lower part of the sliding door 16. The support member 33 is fixed on the inside of the sliding door 16 by a fastening member 33A (see FIG. 7). A rotary part (swing part) 32 constituting a part of the lower guide part 26 is supported by the support member 33. The support member 33 rotatably supports the rotary part 32. The rotary part 32 can rotate with respect to the support member 33 using a rotary shaft 32A as a center. In this manner, the rotary part 32 is formed to be rotatable with respect to the sliding door 16.

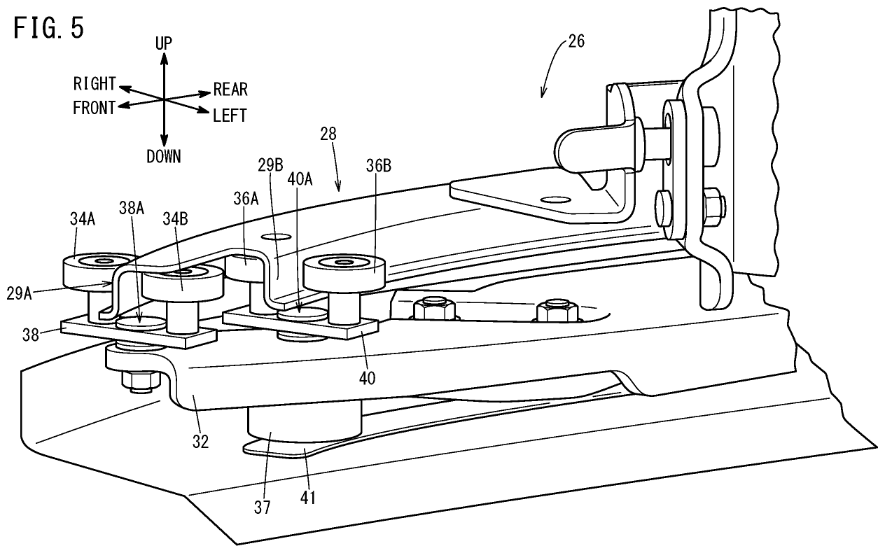

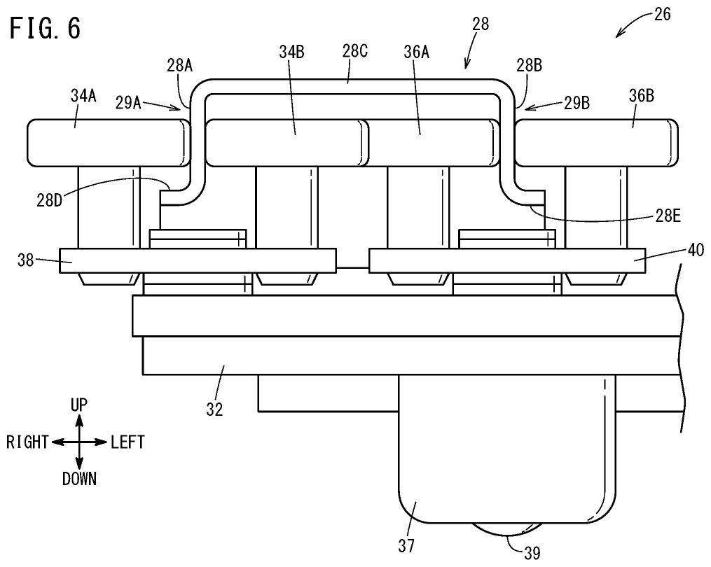

FIG. 5 is a perspective view illustrating the lower guide part. FIG. 6 is a side view illustrating the lower guide part.

As illustrated in FIG. 5 and FIG. 6, the lower guide part 26 includes a pair of first rollers (first guide rollers) 34A and 34B holding the first guide rail 29A therebetween. The lower guide part 26 further includes a pair of second rollers (second guide rollers) 36A and 36B holding the second guide rail 29B therebetween.

On an upper surface side of the rotary part 32, a first roller support part 38 is provided. The first roller support part 38 is coupled to the rotary part 32 through a coupling member 38A. The rotary part 32 rotatably supports the first roller support part 38. The first roller support part 38 rotatably supports the pair of first rollers 34A and 34B.

On the upper surface side of the rotary part 32, a second roller support part 40 is further provided. The second roller support part 40 is coupled to the rotary part 32 through a coupling member 40A. The rotary part 32 rotatably supports the second roller support part 40. The second roller support part 40 rotatably supports the pair of second rollers 36A and 36B.

On a lower surface side of the rotary part 32, a rolling roller (ball roller) 37 is provided. At a lower part of the rolling roller 37, a rolling body 39 (see FIG. 6) is provided. Below the lower rail 28, a rolling surface 41 (see FIG. 5) is provided. When the sliding door 16 is opened and closed, the rolling body 39 rolls on the rolling surface 41. The top part 28C and the flange part 28D restrict the positions of the first rollers 34A and 34B in an up-down direction. The top part 28C and the flange part 28E restrict the positions of the second rollers 36A and 36B in the up-down direction.

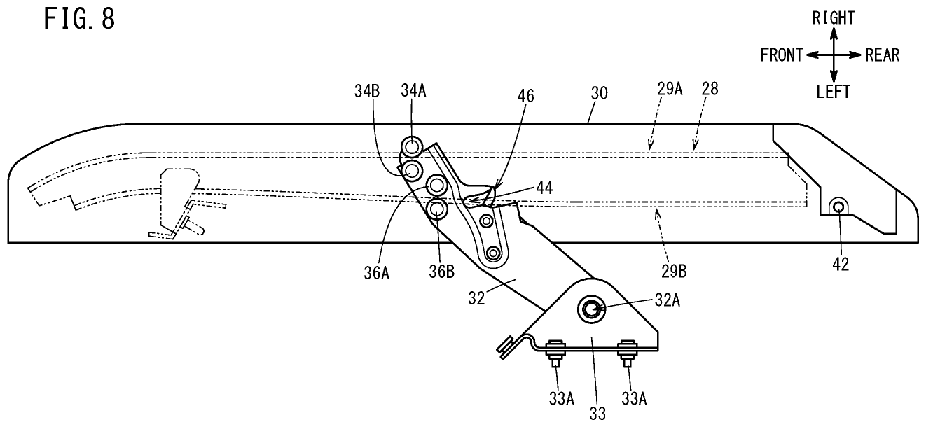

FIG. 7 and FIG. 8 are plan views illustrating an operation of the sliding door structure according to the present embodiment. FIG. 7 illustrates a state in which the sliding door 16 is closed. FIG. 8 illustrates a state in which the sliding door 16 is opened halfway.

As described above, the distance between the first guide rail 29A and the second guide rail 29B in the vehicle width direction is different depending on the position in the longitudinal direction of the lower rail 28 (front-rear direction of vehicle body 13). Therefore, the rotary part 32 rotates as the sliding door 16 is opened. That is to say, the rotary part 32 rotates as the position of the sliding door 16 is changed in the front-rear direction of the vehicle body 13. When the rotary part 32 rotates as the sliding door 16 is opened, the distance between the rotation shaft 32A and the center line of the vehicle body 13 in the longitudinal direction is increased. That is to say, when the rotary part 32 rotates as the sliding door 16 is opened, the distance between the sliding door 16 and the center line of the vehicle body 13 in the longitudinal direction is increased.

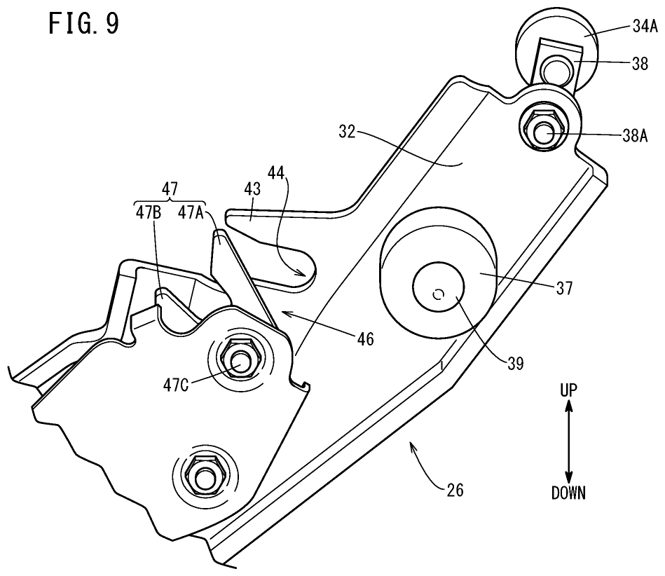

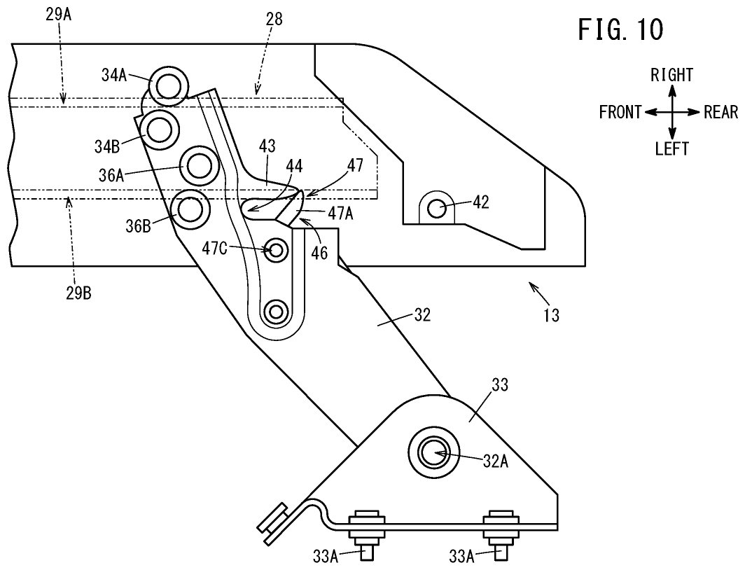

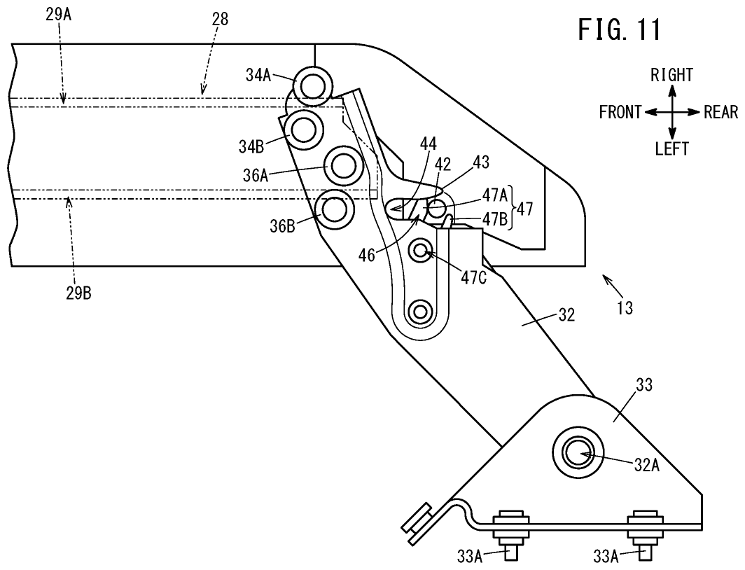

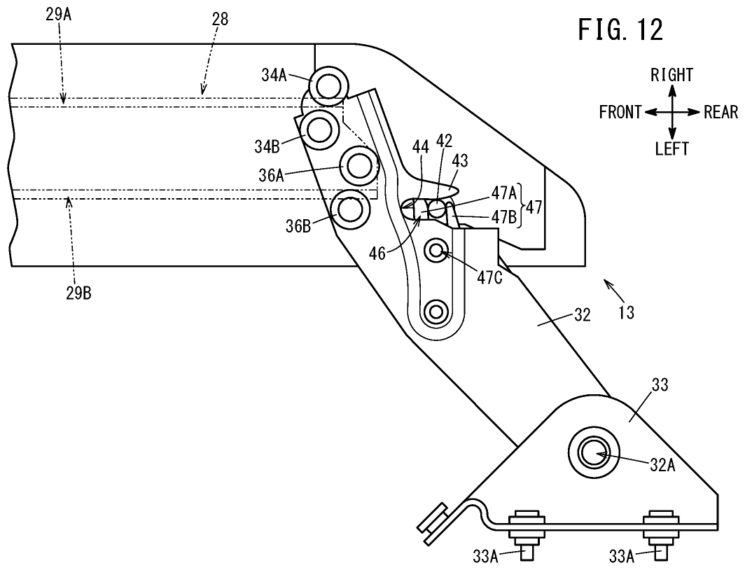

FIG. 9 is a perspective view illustrating the lower guide part. FIG. 9 illustrates the lower guide part 26 viewed from below. FIG. 10 to FIG. 12 are plan views illustrating the operation of the sliding door structure according to the present embodiment. FIG. 10 illustrates a state before a lock member 47 of a lock mechanism 46 to be described below is brought into contact with a stopper pin 42. FIG. 11 illustrates a state in which the lock member 47 is in contact with the stopper pin 42. FIG. 12 illustrates a state in which the stopper pin 42 is locked by the lock mechanism 46.

As illustrated in FIG. 10 to FIG. 12, the vehicle body 13 includes the stopper pin 42. The stopper pin 42 is used to stop the movement of the sliding door 16. The stopper pin 42 is disposed near the rear end part of the lower rail 28.

As illustrated in FIG. 9 to FIG. 12, the rotary part 32 includes a concave part (cut, notch) 44. The concave part 44 is formed by forming, in the rotary part 32, a protrusion (claw) 43 protruding rearward of the vehicle body 13. When the sliding door 16 is fully opened, the stopper pin 42 is positioned within the concave part 44. When the rotary part 32 is positioned near the rear end part of the lower rail 28, a longitudinal direction of the concave part 44, that is, a cutting direction of the concave part 44 is parallel to the front-rear direction of the vehicle body 13. Therefore, in the state where the stopper pin 42 is positioned in the concave part 44, the relative positional relation between the rotary part 32 and the stopper pin 42 can be restricted in the vehicle width direction.

The rotary part 32 further includes the lock mechanism 46 for locking the stopper pin 42 positioned in the concave part 44. As illustrated in FIG. 9, the lock mechanism 46 includes the lock member 47 formed with a U-like shape. The lock member 47 includes a first arm 47A and a second arm 47B. The first arm 47A and the second arm 47B constitute a part of the U-like shape. The lock member 47 is coupled to the rotary part 32 with a coupling member 47C. The coupling member 47C rotatably supports the lock member 47. Before the lock mechanism 46 operates, the lock member 47 is rotatable with respect to the rotary part 32. While the lock mechanism 46 is in operation, the lock member 47 is unrotatable with respect to the rotary part 32. Note that the lock can be canceled by a predetermined operation on the lock mechanism 46.

Before the lock member 47 is brought into contact with the stopper pin 42, the second arm 47B is housed in the rotary part 32 and the first arm 47A protrudes out of the rotary part 32 as illustrated in FIG. 10. That is to say, the first arm 47A can be brought into contact with the stopper pin 42.

As the sliding door 16 is opened, the first arm 47A is brought into contact with the stopper pin 42, and thus, the lock member 47 rotates with respect to the rotary part 32 as illustrated in FIG. 11.

When the rotation of the lock member 47 has reached a predetermined level, the lock mechanism 46 starts to operate. As illustrated in FIG. 12, the lock member 47 becomes unrotatable with the first arm 47A positioned on one side of the stopper pin 42 (on the front side of vehicle body 13) and the second arm 47B positioned on the other side of the stopper pin 42 (on the rear side of vehicle body 13). Therefore, in the state where the lock mechanism 46 is in operation, the relative positional relation between the rotary part 32 and the stopper pin 42 can be restricted in the front-rear direction of the vehicle body 13. As described above, in the state where the stopper pin 42 is positioned within the concave part 44, the relative positional relation between the rotary part 32 and the stopper pin 42 can be restricted in the vehicle width direction. Therefore, in the state where the lock mechanism 46 is in operation, the relative positional relation between the rotary part 32 and the stopper pin 42 can be restricted in the front-rear direction of the vehicle body 13 and the left-right direction of the vehicle body 13. Accordingly, in the state where the sliding door 16 is fully opened, the vibration of the sliding door 16 can be reliably suppressed.

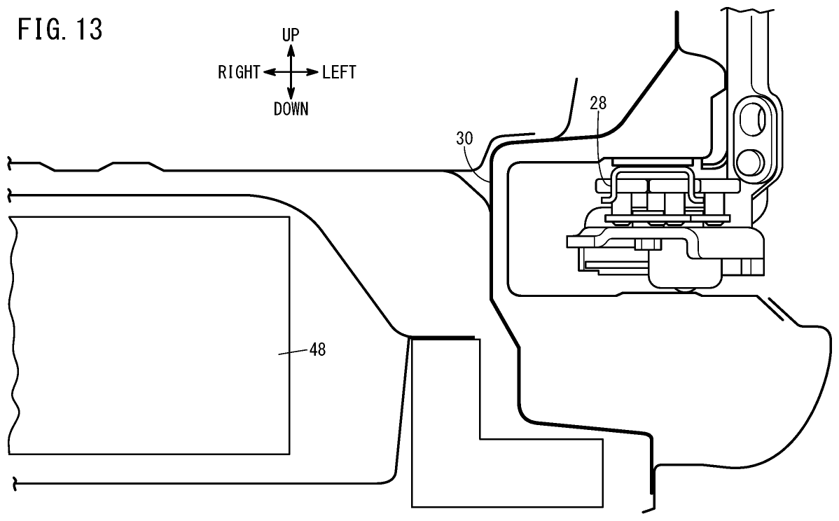

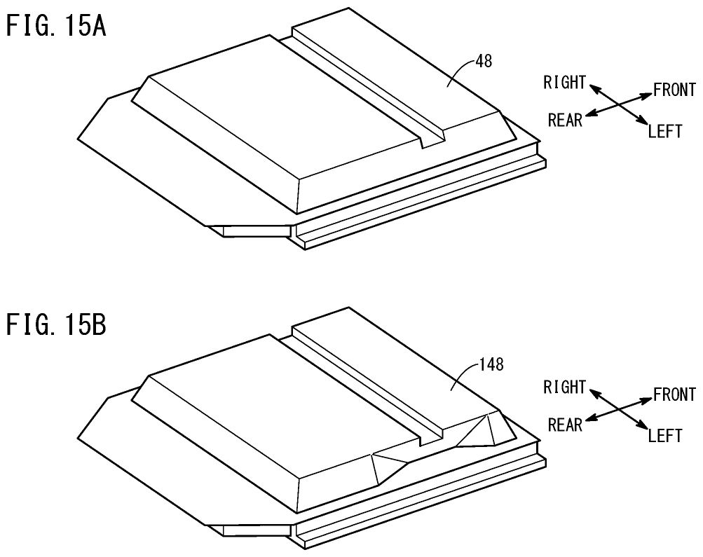

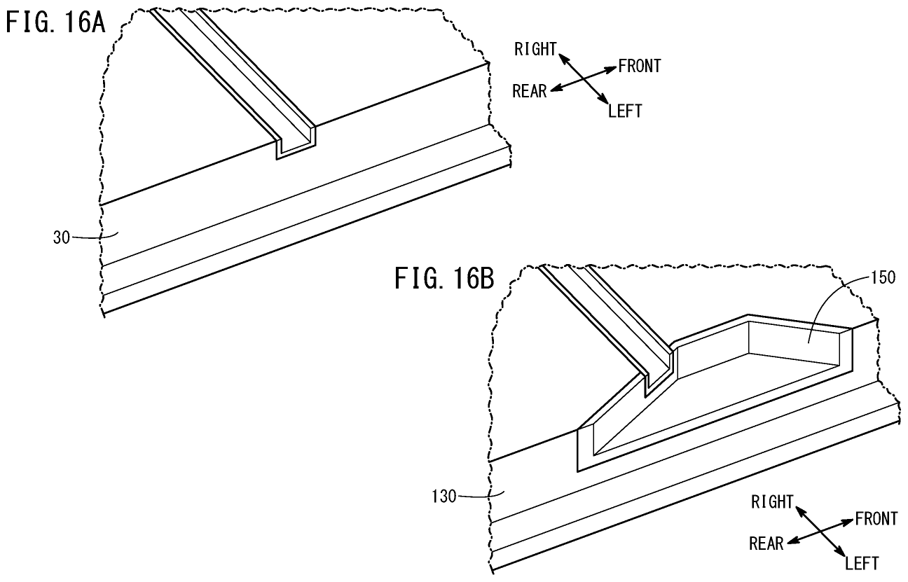

FIG. 13 is a cross-sectional view illustrating a part of the vehicle according to the present embodiment. FIG. 15A is a perspective view illustrating a battery case provided in the vehicle according to the present embodiment. FIG. 16A is a perspective view illustrating a part of the vehicle according to the present embodiment.

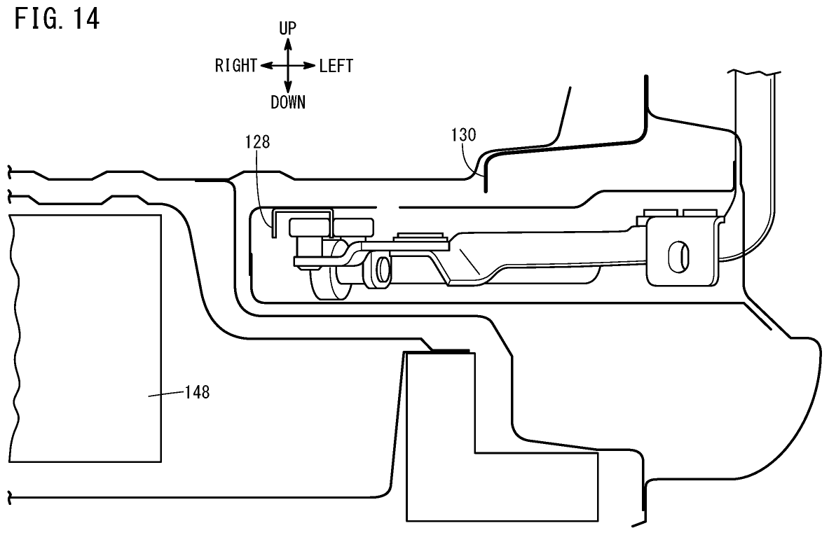

As illustrated in FIG. 13, a side sill 30 is provided at the side part of the vehicle body 13. In the present embodiment, the lower rail 28 is positioned outside the side sill 30. Since the lower rail 28 is disposed outside the side sill 30, the space for housing a battery case 48 (see FIG. 15A) can be secured sufficiently according to the present embodiment. In the present embodiment, the battery capacity corresponding to a width of about 100 mm can be added to or increased with respect to the battery capacity in a comparative example illustrated in FIG. 14, for example. The increase in space for housing the battery can contribute to the improvement of the cruising distance of the vehicle 12. According to the present embodiment, moreover, since the lower rail 28 is disposed outside the side sill 30, a lower rail panel (housing member) 150 (see FIG. 16B) for housing the lower rail 28 inside the side sill 30 is unnecessary. Therefore, according to the present embodiment, since the number of components can be reduced, the cost can be reduced.

FIG. 14 is a cross-sectional view illustrating a part of a vehicle according to the comparative example. FIG. 15B is a perspective view illustrating a battery case provided in the vehicle according to the comparative example. FIG.

16B is a perspective view illustrating a part of the vehicle according to the comparative example.

As illustrated in FIG. 14, a part of a lower rail 128 is positioned inside a side sill 130 in the comparative example. Therefore, in the comparative example, the space for housing a battery case 148 (see FIG. 15B) cannot necessarily be secured sufficiently. In the comparative example, the space for housing the battery is interrupted by about 100 mm by the lower rail panel 150. In the comparative example, the lower rail panel 150 or the like for housing a part of the lower rail 128 inside the side sill 130 is necessary and therefore, the number of components is increased; accordingly, the cost reduction is hindered.

Thus, in the present embodiment, the rotary part 32 includes the pair of first rollers 34A and 34B holding the first guide rail 29A therebetween and the pair of second rollers 36A and 36B holding the second guide rail 29B therebetween. The first rollers 34A and 34B are supported by the first roller support part 38 that is rotatable with respect to the rotary part 32. The second rollers 36A and 36B are supported by the second roller support part 40 that is rotatable with respect to the rotary part 32. The distance between the first guide rail 29A and the second guide rail 29B in the vehicle width direction is different depending on the position in the front-rear direction of the vehicle body 13. By this structure, in the present embodiment, as the sliding door 16 is opened, the rotary part 32 rotates and the distance from the center line of the vehicle body 13 in the longitudinal direction to the sliding door 16 changes. According to the present embodiment, the lower rail 28 does not need to be curved largely in the vehicle width direction; therefore, the space can be saved. Since the sliding door structure 10 can achieve space saving, the space for housing the battery case 48 can be secured sufficiently and the cruising distance can be improved according to the present embodiment.

The preferred embodiment of the present invention has been described above; however, the present invention is not limited to the above embodiment and various modifications are possible without departing from the concept of the present invention.

The summary of the aforementioned embodiment is described below.

The sliding door structure (10) includes: the door (16) configured to cover the opening (14) formed at the side part of the vehicle body (13); the lower rail (28) disposed below the opening, including the first guide rail (29A) and the second guide rail (29B) formed along the first guide rail, and configured to support the door slidably in the front-rear direction of the vehicle body; the rotary part (32) disposed at the lower part of the door and configured to rotate with respect to the door; the pair of first rollers (34A, 34B) holding the first guide rail therebetween; the pair of second rollers (36A, 36B) holding the second guide rail therebetween; the first roller support part (38) provided to the rotary part and configured to rotatably support the pair of first rollers and rotate with respect to the rotary part; and the second roller support part (40) provided to the rotary part and configured to rotatably support the pair of second rollers and rotate with respect to the rotary part. By this structure, as the door is opened, the rotary part rotates and the distance from the center line of the vehicle body in the longitudinal direction to the sliding door changes. By this structure, the lower rail does not need to be curved largely in the vehicle width direction; therefore, the space can be saved. Since the sliding door structure can achieve space saving, the space for housing the battery case can be secured sufficiently and the cruising distance can be improved by this structure.

The rotary part may include the concave part (44) that the stopper pin (42) provided to the vehicle body enters when the door is fully opened, and the lock mechanism (46) configured to lock the stopper pin having entered the concave part. By this structure, the relative positional relation between the rotary part and the stopper pin can be reliably restricted, and thus, the vibration of the door when the door is fully opened can be reliably suppressed.

The distance between the first guide rail and the second guide rail in the vehicle width direction may be different depending on the position in the longitudinal direction of the lower rail. By this structure, the rotary part can be rotated sufficiently without curving the lower rail largely in the vehicle width direction; therefore, the space can be saved.

The lower rail may be disposed outside the side sill (30) provided to the vehicle body. By this structure, since the space for housing the battery case can be secured sufficiently, the battery capacity can be improved.

The sliding door structure may further include the upper rail (24) disposed above the opening and configured to support the door slidably in the front-rear direction of the vehicle body.

The vehicle (12) includes the sliding door structure as described above.

What is claimed is:

1. A sliding door structure comprising:
a door configured to cover an opening formed at a side part of a vehicle body;
a lower rail disposed below the opening, including a first guide rail and a second guide rail formed along the first guide rail, and configured to support the door slidably in a front-rear direction of the vehicle body;
a rotary part disposed at a lower part of the door and configured to rotate with respect to the door;
a pair of first rollers holding the first guide rail therebetween;
a pair of second rollers holding the second guide rail therebetween;
a first roller support part provided to the rotary part and configured to rotatably support the pair of first rollers and rotate with respect to the rotary part; and
a second roller support part provided to the rotary part and configured to rotatably support the pair of second rollers and rotate with respect to the rotary part.

2. The sliding door structure according to claim 1, wherein the rotary part includes a concave part that a stopper pin provided to the vehicle body enters when the door is fully opened, and a lock mechanism configured to lock the stopper pin having entered the concave part.

3. The sliding door structure according to claim 1, wherein a distance between the first guide rail and the second guide rail in a vehicle width direction is different depending on a position in a longitudinal direction of the lower rail.

4. The sliding door structure according to claim 1, wherein the lower rail is disposed outside a side sill provided to the vehicle body.

5. The sliding door structure according to claim 1, further comprising an upper rail disposed above the opening and configured to support the door slidably in the front-rear direction of the vehicle body.

6. A vehicle comprising a sliding door structure, the sliding door structure comprising:
a door configured to cover an opening formed at a side part of a vehicle body;
a lower rail disposed below the opening, including a first guide rail and a second guide rail formed along the first guide rail, and configured to support the door slidably in a front-rear direction of the vehicle body;
a rotary part disposed at a lower part of the door and configured to rotate with respect to the door;
a pair of first rollers holding the first guide rail therebetween;
a pair of second rollers holding the second guide rail therebetween;
a first roller support part provided to the rotary part and configured to rotatably support the pair of first rollers and rotate with respect to the rotary part; and
a second roller support part provided to the rotary part and configured to rotatably support the pair of second rollers and rotate with respect to the rotary part.
